(19) United States
(12) Patent Application Publication
(10) Pub. No.: US 2021/0187602 A1
(43) Pub. Date: Jun. 24, 2021

(54) METHOD AND DEVICE FOR MOLDING PARTICULARLY OF A METALLIC GLASS

(71) Applicant: ROCTOOL, LE BOURGET DU LAC (FR)

(72) Inventor: JOSÉ FEIGENBLUM, SAINT PAUL (FR)

(21) Appl. No.: 16/757,758

(22) PCT Filed: Oct. 25, 2018
(86) PCT No.: PCT/EP2018/079357

§ 371 Date: Apr. 20, 2020

(30) Foreign Application Priority Data
Oct. 25, 2017 (FR) FR1771119

(51) Int. Cl. B22D 17/20; B22D 17/04; B22D 25/06; F27B 14/06; F27D 11/12

(52) U.S. Cl. CPC B22D 17/2038; B22D 17/04; F27D 11/12; B22D 25/06; F27B 14/061; B22D 17/203

(57) ABSTRACT

A device to produce a part by molding a bulk metallic glass (BMG) includes a mold, a melting device to melt the BMG and a sectorized piston. The mold includes two rigid sections delimiting a molding cavity. The melting device includes a cold sectorized crucible or melting crucible, an inductor and a current generator to generate a high-frequency current to power the inductor. The melting crucible is arranged vertically having hollow sectors formed from an electrically conductive and non-magnetic material electrically insulated from one another. The inductor is in the form of a coil and surround the melting crucible to heat the content thereof. The sectorized piston has hollow sectors formed from the electrically conductive and non-magnetic material electrically insulated from one another, closing the melting crucible at one of the ends thereof.

The invention relates to a method and a device for molding, particularly of a metallic glass. The invention is more particularly, but not exclusively, suitable for the manufacture of cases for electronic equipment, more particularly intended for smartphones.

Indeed, metallic glasses, presented in the form of an amorphous, non-crystallized or partially crystallized metal, which due to the lack of grain boundaries in the metal structure, exhibit hardness, elasticity and corrosion resistance characteristics, rendering same particularly high-performing for this type of application and rendering unnecessary protective cases wherein consumers encase their smartphone in order protect same from shocks, scratches and render same waterproof.

According to the techniques of the prior art, such cases are obtained from a sheet of amorphous metal alloy, which is shaped by a blow molding method, similar to glass shaping methods, in a mold with the shape of the case after having heated the sheet to a relatively low temperature compared to the temperature that it would be necessary to reach with the same crystallized metal alloy to obtain an equivalent shaping.

According to a further embodiment, the methods according to the prior art use a vacuum molding technique of a bulk metallic glass (or BMG). The use of a BMG makes it possible to reduce the critical cooling rate enabling the solidification of the material into an amorphous material. To ensure a low degree of crystallinity or a high degree of amorphization, the material must be molded under conditions preventing the contamination thereof by impurities, particularly by nitrogen and oxygen. To this end, the melting and casting operations are carried out in a vacuum or in an inert atmosphere. The material is melted in a crucible by means of induction heating, then injected into the mold. The techniques according to the prior art use either a crucible consisting of a magnetic field-transparent material, such as a zirconia crucible, or a cold sectorized copper crucible.

A channel, generally referred to an injection or casting crucible, makes it possible to connect the content of the melting crucible with the mold cavity while keeping the whole in a vacuum. The connection between the melting crucible and the injection crucible must be closed during the melting operation, then opened to enable casting, which is carried by movable closing means, such as a flap, a piston or a movable tappet. When the melting crucible is positioned vertically, for example above the mold, and gravity tends to bring the melting charge closer to the movable closing means, the latter must be cooled, so as particularly not to damage the means ensuring tightness between the movable closing means and the injection crucible, the melting charge is cooled in contact with the movable closing means and during each casting, there remains a skull of material on the surface thereof, which is liable to impede the operation of the device and must be removed.

The ceramic crucible further has the drawback of reacting with certain alloys.

The cold sectorized crucible makes it possible to distance the melting charge from the walls of the crucible by Laplace magnetic forces, but does not solve the problem of skull creation. Thus, according to the prior art, the crucible is positioned horizontally, and the Laplace forces offset gravity, the charge being subject to levitation or pseudo-levitation inside the tube formed by the crucible. The injection of material into the mold involves the use of a cooled piston, moving in the crucible and which pushes the charge into the molding cavity. Alternatively, the crucible is positioned vertically and is closed by a cooled removable bottom, forming a flap between the melting crucible and the mold. In these embodiments of the prior art, the molten material is cooled in contact with the piston or the flap and there also remains a skull of material in contact therewith, which must be removed periodically, or even for each casting.

Document JPH 091742119 discloses a crucible and a rigid section molding of an aluminum alloy, comprising a crucible disposed horizontally, and wherein a material melted beforehand is poured.

Document US2015/0298206 describes a device and a method for molding a BMG comprising a melting crucible formed from an electromagnetic field-transparent material, the BMG being molten injected into the mold through a cooled piston.

Document U.S. Pat. No. 5,156,202 describes a sectorized mold that is closed in the lower portion thereof by a sectorized and cooled plate, comprising an opening at the center thereof. A molten metal is introduced through the upper portion of the mold that is closed in the lower portion thereof by the sectorized plate. A piston pushes the material against the walls of the mold and of the sectorized plate in contact with which it cools. The mold is surrounded by a coil powered with high-frequency alternating current.

Document WO2013/190020 describes a mold comprising means of induction heating and means of cooling.

Document US2002/0122456 describes a melting furnace comprising a sectorized crucible surrounded by an induction coil.

The invention aims to resolve the drawbacks of the prior art and relates to this end to a device for producing a part by molding a BMG, the device comprising:

a. a mold comprising two rigid sections delimiting a sealed molding cavity;

b. a device for melting the BMG comprising:

bi. a cold sectorized crucible, or melting crucible, arranged vertically comprising hollow sectors formed from an electrically conductive and non-magnetic material electrically insulated from one another;

bii. an inductor in the form of a coil surrounding the melting crucible for heating the content thereof;

biii. a means for generating very high-frequency current for powering the inductor; the device comprising a sectorized piston comprising hollow sectors formed from an electrically conductive and non-magnetic material electrically insulated from one another, closing the melting crucible at one of the ends thereof;

d. means for connecting the content of the melting crucible with the molding cavity and casting the BMG.

Thus, the vertical arrangement of the melting crucible with respect to the mold facilitates automation of the casting method by making it possible to benefit from gravity in the implementation of a plurality of operations. The sectorized crucible makes it possible to distance the molten material from the walls of the crucible and thereby prevent any contamination thereof, whereas the use of a sectorized piston makes it possible to place the melting charge in levitation or pseudo-levitation with respect to the piston by the Laplace force components of the magnetic field created by the flow of the induced currents on the sectors of the piston. The melting charge not being in contact either with the melting crucible, or with the piston during melting and casting, the device according to the invention enables the use of BMG comprising reactive compounds such as titanium or zirconium that would interact with a crucible made of refractory material. The charge is not cooled by contact with the piston and does not create a skull.

The invention is advantageously implemented according to the embodiments and alternative embodiments disclosed hereinafter, which are to be considered individually or according to any technical feasible combination.

Advantageously, the means for connecting the content of the melting crucible with the molding cavity, comprise a device for vertical movement of the piston. Thus, due to the vertical arrangement of the melting crucible with respect to the mold, the piston makes it possible to carry out casting using gravity or by injection, still without contact of the piston with the molten charge.

Thus, according to a first embodiment, the melting crucible is positioned above the molding cavity and the piston moves downwards. And according to a second embodiment, the melting crucible is positioned below the molding cavity and the piston moves upwards.

Advantageously, the device according to the invention comprises a channel, or injection crucible between the melting crucible and the molding cavity. This embodiment makes it possible to position the melting device outside the dies shells, the passage through the dies shells, from the melting device towards the cavity, being carried out by this injection crucible.

Advantageously, the device according to the invention comprises a coil surrounding the injection crucible and powered with high-frequency current. The induction effect produced by this coil makes it possible to retain the temperature of the molten charge until the entry thereof into the molding cavity and also to distance the molten charge from the walls of the injection crucible.

Advantageously, the device according to the invention comprises, according to an embodiment compatible with the preceding embodiments, an injection coil and means for the electrical power supply thereof, suitable for producing an electromagnetic force for the injection of the molten material contained in the melting crucible into the molding cavity. This embodiment enables the use of Laplace forces by the coil so as to inject the molten material into the mold without contact with the material at the time of injection.

According to a first alternative embodiment, the injection coil is a flat coil powered by a capacitor discharge. This embodiment uses a similar configuration to that used in electromagnetic forming to apply to the melting material a force directing it towards the molding cavity.

According to a second alternative embodiment, compatible with the first, the injection coil comprises a coil imbricated in the coil forming the melting coil, the injection coil being powered by a high-frequency alternating current out of phase with respect to the alternating current powering the melting coil so as to create a sliding field. Thus, the combined action of the coil forming the melting inductor and of the injection coil creates a sliding field favoring the injection of the material into the molding cavity.

Advantageously, the sectors of the melting crucible and the piston are made of stainless steel, thereby providing a greater durability than copper, generally used for this purpose and also enabling to lighten the piston for a more rapid movement thereof during the casting process.

Advantageously, the mold comprises an induction heating means of the molding cavity. The induction means makes it possible to rapidly bring the molding cavity to a suitable temperature during casting, so as to favor the filling of the cavity.

Advantageously, the mold of the device according to the invention further comprises a means for cooling the molding cavity. Thus, the cycle times are reduced.

The invention also relates to a method implementing any one of the embodiments according to the invention, for molding a part from a BMG and comprising the steps of:

i. charging the crucible;

ii. closing the mold and evacuating the molding cavity;

iii. melting the charge;

iv. preheating the mold by means of the mold induction circuit;

v. carrying out casting by moving the sectorized piston;

vi. cooling the mold by circulating a coolant in the mold induction circuit;

vii. opening the mold and releasing the part from the mold.

The melting device of the molding device according to the invention makes it possible to retain the molten charge at a high temperature until injection, while preheating the mold ensures a satisfactory flow of the material during casting and complete filling of the cavity. The sectorized piston of the device according to the invention prevents the creation of a skull on the surface of the piston during melting and casting and thus cleaning operations of the piston. The use of induction heating of the mold makes it possible to bring same rapidly to the suitable temperature for casting and thereby perform a series of cycles in rapid succession while ensuring effective and rapid cooling of the part after casting.

Advantageously, steps iii) and iv) are carried out in a parallel manner, so as to reduce the cycle time further.

The invention is disclosed hereinafter according to the preferred, non-restrictive, embodiments thereof, and with reference to FIGS. 1 to 7, wherein:

FIG. 1 represents, according to a sectional view, a schematic diagram of the device according to the invention, with a melting device positioned above the mold, during the melting of the charge;

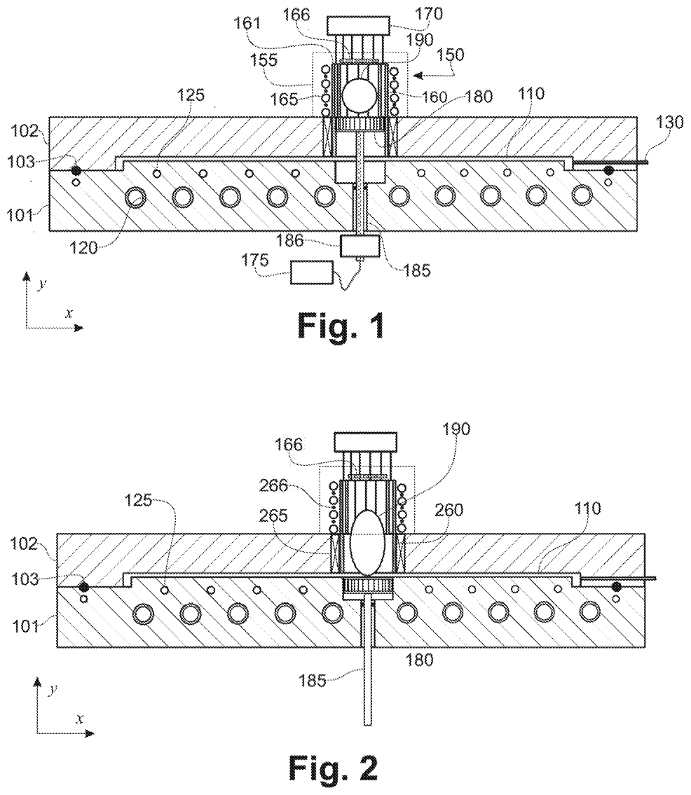

FIG. 2 shows the device in FIG. 1 at the beginning of casting;

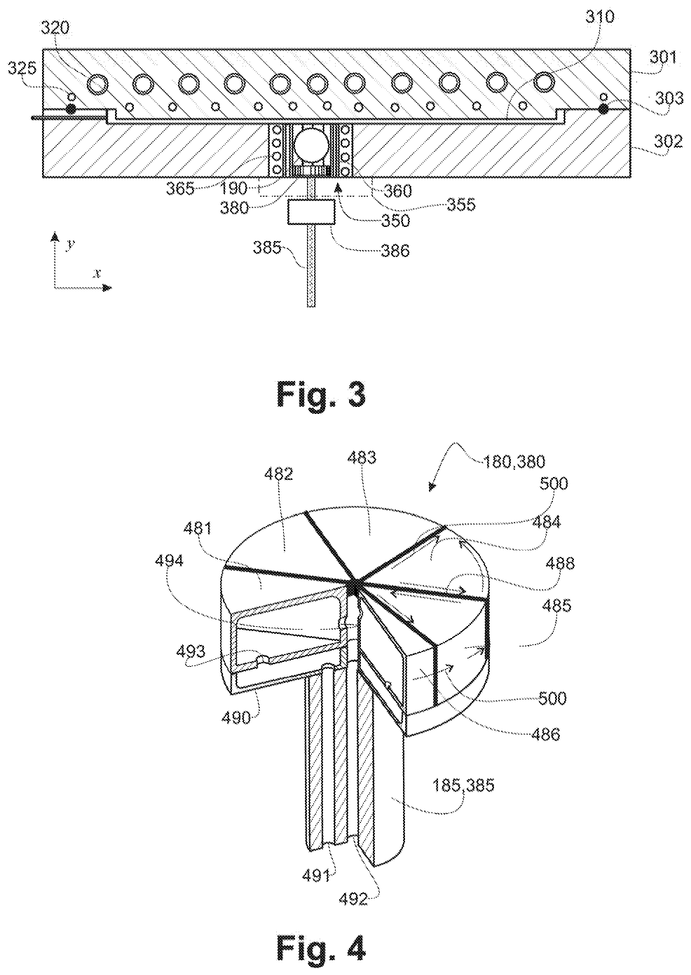

FIG. 3 is a schematic diagram, according to a sectional view, of a further embodiment of the device according to the invention wherein the melting device is positioned below the mold;

FIG. 4 represents schematically according to a perspective and partial sectional view, an example of embodiment of the sectorized piston of the device according to the invention;

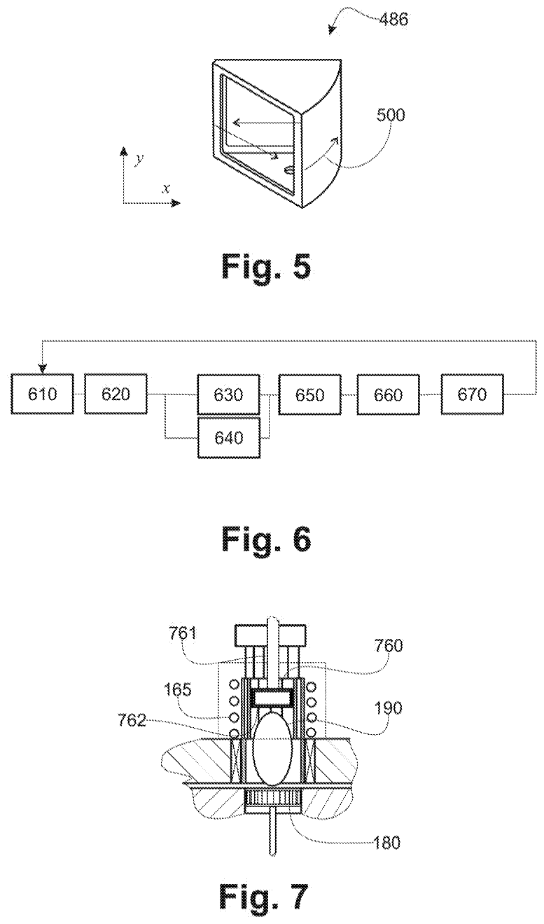

FIG. 5 is a perspective view of an exemplary embodiment of a sector of the piston as represented in FIG. 4;

FIG. 6 shows a synopsis of the method according to the invention; and

FIG. 7 represents according to a partial view of the melting device, corresponding to the cross-section represented in FIGS. 1 and 2, an exemplary embodiment of the device according to the invention comprising an injection piston.

The drawings in FIGS. 1 to 5 and 7 are schematic representations of the device according to the invention, intended for understanding the operation of the essential means of the invention. In all these Figures, the y axis represents the upward vertical direction. So as not to overload the Figures, the power supply means of the inductors and the coils have not been represented.

In FIG. 1, the device is represented during the BMG melting phase. According to an exemplary embodiment, the device according to the invention comprises a mold in two, or more, separable parts (101, 102), which, when closed, define a sealed molding cavity (110). Sealing means (103) make it possible to ensure the sealing of the cavity in a primary vacuum, and under slight inert gas pressurization. The two parts (101, 102) of the mold are for example fastened to the platens of a press so as to enable opening and closure of the mold. At least one (101) of the parts of the mold comprises means for heating the surfaces of the molding cavity (110), for example in the form of inductors (120) extending in channels formed in the mold. The inductors are for example formed by copper tubes or multi-strand copper wires of suitable cross-section for the electrical induction current used. The inductors (120) are connected to a high-frequency current generator (not shown). The two parts (101, 102) of the mold are made of a metallic material, for example steel or copper. In the case where the material forming the parts of the mold is not ferromagnetic, for example if these parts are made of copper, the surfaces of the channels receiving the inductors (120) are coated with a ferromagnetic material, for example with nickel. The thickness of the coating layer is dependent on the heating power and the frequency of the current supplying the inductors, it is typically between 0.1 mm and 1 mm. When the inductors (120) are supplied with a high-frequency alternating current, they heat the walls of the channels, and the heat produced thereby is propagated by conduction to the surfaces of the molding cavity (110). Typically, the heating inductors of the mold are supplied with an alternating current of a frequency between 10 KHz and 200 KHz by a generator of a power between 10 KW and 100 KW without these values being limiting. According to an exemplary embodiment, at least one of the parts of the mold comprises channels (125) for circulating a coolant and cooling the molding cavity (110). According to exemplary embodiment, the coolant is a liquid such as water or oil, or a gas. According to this embodiment example, the cooling channels (125) are positioned between the molding cavity and the inductors, as closely as possible to the surface of the molding cavity so as to ensure rapid cooling and a high degree of amorphization thereof. The position of the inductors, the installed heating power, the number and distribution of the cooling channels as well as the flow rate of coolant required for cooling, are for example determined by digital simulation of the heating and cooling cycles of the mold.

Means (130) make it possible to evacuate the molding cavity and introducing an inert gas, such as argon, therein, so as to create therein slight pressurization with respect to atmospheric pressure.

The mold comprises a melting device (150), located above the mold, according to this exemplary embodiment. This device is connected with the molding cavity and confined in an enclosure (155) tightly assembled with the mold such that evacuation of the mold cavity also places the melting device in a vacuum, and it is also slightly pressurized in the case of the injection of an inert gas. This melting device (150) comprises a melting crucible (160) surrounded by a melting coil (165) powered by a very high-frequency current generator. The melting crucible (160) is a sectorized crucible, of overall cylindrical shape comprising a plurality of hollow sectors (161), extending along the axis of the cylinder and electrically insulated from one another. The sectors are made of a non-magnetic metallic material, for example copper or stainless steel. Cooling means (170) make it possible to circulate a coolant in the hollow sectors, so as to cool them. According to one exemplary embodiment, the part of the melting crucible communicating with the molding cavity (110) is, during melting, closed by a piston (180), connected to an operating rod (185) for the retraction thereof. The device comprises for this purpose means (186) actuating the operating rod, such as a rack-and-pinion system, an electric cylinder, a linear motor or any other means known from the prior art for moving the piston and the operating rod.

The piston (180) forms, during the melting of the material (190) a sole relative to the melting crucible (160). However, the piston (180) is sectorized and comprises, similarly to the melting crucible, a plurality of hollow sectors, formed from an electrically conductive metallic material and electrically insulated from one another. Means (175) make it possible to circulate fluid in the hollow sectors of the piston, for example via the operating rod so as to cool them. Unlike a conventional sole, the sectorized design and the electrically conductive nature of the sectors of the piston (180) make it possible, via the circulation of induced currents in the sectors thereof during the power supply of the melting coil (165), to create Laplace forces, repelling the melting charge from the surface of the piston (180) situated in the melting crucible. Thus, the molten charge (190) is in electromagnetic levitation or pseudo-levitation in the crucible, without contact with the walls.

The arrangement of the melting crucible in the vertical position above the mold makes it possible to charge the crucible gravitationally, the mold being closed. The charge is formed from granules of the constituent material of the BMG, or of a plurality of materials, the alloy whereof forms the BMG, the alloy being produced during melting. According to a further alternative embodiment, the charge is formed from a single solid blank, such as a cylinder.

The solid charge being introduced into the melting crucible, the latter being closed at the bottom end thereof by the piston (180) and the mold being closed, the whole being evacuated, the melting coil (165) is powered with very high-frequency current. Alternatively, after the evacuation, an inert gas is introduced into the molding cavity and into the enclosure comprising the melting crucible. The induced currents heat the charge which starts melting. The sectorized nature of the crucible and the resulting magnetic field distance the melting charge from the walls of the crucible, just like the walls of the piston (180), itself sectorized. The melting of the charge is extremely rapid due to the direct heating thereof by induction. The Laplace forces generated keep the melting charge away from the walls of the crucible and the piston, the circulation of the induced currents in the melting charge also mixing the charge, which makes it possible to ensure the homogeneity thereof particularly when the latter comprises a plurality of alloy elements of different specific masses.

According to this embodiment example, a flat coil (166) connected to a series of capacitors is positioned immediately above the melting crucible.

In FIG. 2, the device in FIG. 1, is represented during the injection phase. The charge being molten, in order to carry out injection, the molding cavity is preheated, by means of the inductors (120) to bring same to a temperature equal to or slightly less than the glass transition temperature of the BMG. According to this embodiment example, where the melting device is positioned above the mold, the piston (180) is retracted into the mold by moving same downwards via the operating rod (185) thereof thereby releasing the passage to the molding cavity (110). The melting charge (190) then flows gravitationally into the molding cavity. The surfaces of the molding cavity having been preheated, the molten material flows into the cavity while retaining a sufficient fluidity to fill the cavity entirely. Then, the molding cavity is cooled by circulating a coolant into the cooling channels (125). An electronic control device (not shown) makes it possible to synchronize and sequence the power supply of the melting coil, heating of the molding cavity, retraction of the piston, shutdown of power supply of the melting coil and cooling of the molding cavity.

According to one advantageous embodiment, the flat coil (166) is powered by capacitor discharge synchronized with the descent of the piston (180). The power supply of the flat coil (166) creates an electromagnetic force acting upon the melting charge, which pushes the charge towards the molding cavity.

According to one advantageous embodiment, an injection coil (266) is imbricated in the melting coil and powered during injection by a high-frequency alternating current simultaneously with the power supply of the coil (165), the two coils (165, 266) being powered by out-of-phase alternating currents, so as to create a sliding field which tends to eject the melting charge from the melting crucible towards the molding cavity.

The use of such an injection coil is, according to one embodiment, complementary to the use of the flat coil, to carry out the injection of the melting charge in the molding cavity.

According to one embodiment, the melting crucible (160) is extended by an injection crucible or cylinder (260) which is advantageously surrounded by a coil (265) powered by a high-frequency current and forming an inductor. The injection crucible is for example made of an electromagnetic field-transparent refractory material, without this design being limiting. This injection crucible makes it possible to traverse the thickness of the part of the mold separating the melting crucible (160) from the molding cavity, while keeping the molten charge sufficiently hot. Thus, the electrical power supply of the coil (265) surrounding the injection crucible (260) has the effect, on one hand, of distancing the melting charge (190) from the walls of the injection crucible (260) and, on the other, of keeping, by the inductive heating effect, the melting charge at a sufficient temperature prior to the entry thereof into the molding cavity.

The power supply of the injection inductor, the flat coil (166), the injection coil (266), the coil (265) surrounding the injection crucible (260) as well as the piston movement are controlled, sequenced and synchronized by electronic means, for example by a programmable logic controller (not shown).

In FIG. 7, according to a further embodiment, the device according to the invention comprises a piston (760) suitable for pushing the charge (190) into the molding cavity. The piston comprises a head (762) and an operating rod (761) for the vertical movement thereof, the movement being carried out by an electric, hydraulic or pneumatic cylinder actuating the rod (761), by a rack-and-pinion system, a linear motor or any other suitable means. The head (762) of the piston is, according to embodiment examples, a solid head or a hollow head, made of a ferromagnetic material or coated with a ferromagnetic material. Operated by the operating rod (761), the head (762) moves axially in the melting crucible, where it is subjected to the effect of the induced currents generated by the melting inductor (165). The response of the material forming the piston head or the coating thereof to the induced currents induces a rapid rise in the temperature of the surface of the head. According to one embodiment example, the head (762) is further cooled by the circulation of a coolant circulated by means (not shown) between the operating rod (761) and the piston head. The sizing of the piston head, the composition thereof and any cooling thereof make it possible to bring the surface of the piston head in contact with the melting charge (190) during casting, to a temperature such that the latter is sufficiently high so as not to create a skull on the surface of the head and sufficiently low so as not to induce a bonding or welding phenomenon of the molten material on the head.

According to alternative combinations of these embodiments disclosed hereinabove, the device according to the invention enables basic gravitational casting and only comprises for this purpose the segmented piston (180), or magnetic field-assisted gravitational casting, this combination comprising the segmented piston (180) associated with the injection coil (266) and/or the flat coil (166). According to a further alternative embodiment corresponding to a mechanical injection, the device according to the invention comprises the retractable segmented piston (180) acting as a sole in the bottom part of the melting crucible and an injection piston (760) pushing the charge into the cavity. According to a further alternative embodiment of the latter embodiment comprising an injection piston (760), the device according to the invention further comprises an injection coil (266) suitable for creating a sliding magnetic field. After filling the molding cavity, the circulation of a coolant in the cooling channels (125) of the mold makes it possible to rapidly cool the molding cavity and the part contained therein, thereby ensuring a high degree of amorphization thereof. The mold is then opened, the part released from the mold and the cycle is resumed.

Although FIGS. 1 and 2 represent the device according to the invention in an embodiment comprising an injection crucible and coils (166, 266) suitable for favoring the injection of the molten charge into the molding cavity, those skilled in the art understand that these features are improvements and are not essential for the operation of the device according to the invention, merely moving the piston (180) making it possible to carry out gravitational casting, the latter being optionally assisted by the mechanical effect of an injection piston. In this case, the melting device is positioned, for example, directly in the bottom part (102) of the mold, similarly to the embodiment represented in FIG. 3, but with the piston (180) positioned below the melting crucible, on the side of the molding cavity (110).

In FIG. 3, according to a further embodiment of the device according to the invention, the melting device (350) is positioned vertically below the molding cavity (310) of the mold. Similarly to the other embodiments, the mold comprises at least two separable parts (301, 302) and associated sealing means (303), such that on closing the mold, the parts define therebetween a sealed molding cavity (310), suitable for being evacuated by suitable means, and being filled with a slightly pressurized inert gas. The two parts (301, 302) of the mold are for example mounted on the platens of a press, which enables opening and closure of the mold. At least one (301) of the parts of the mold advantageously comprises means for heating the surfaces of the molding cavity (310), for example in the form of inductors (320) extending into channels formed in the mold. At least one of the parts of the mold advantageously comprises cooling (325) channels (325) suitable for cooling the molding cavity (310) rapidly.

The vertical arrangement of the melting device (350) below the mold makes it possible to discharge the charge into the melting device gravitationally, with the mold open. The melting device (350) comprises a cooled sectorized melting crucible (360) comprising hollow sectors, for example made of stainless steel and electrically insulated from one another. The melting crucible (360) is connected to the molding cavity (310) by the top end thereof, and closed at the bottom end thereof, by a sectorized piston (380). The sectorized piston is attached to an operating rod (385) and operating means (386) make it possible to move the operating rod (386) and hence the piston (380) vertically. An induction coil (365) or melting coil, connected to a high-frequency current generator (not shown) makes it possible to generate a high-frequency alternating magnetic field in the melting crucible and to melt the charge (190) contained therein. The melting device (350) is inserted into a tight enclosure (355).

The solid charge being placed in the melting crucible, closed by the sectorized piston (380), the mold is closed and evacuated. Depending on the material injected, the evacuation is followed by the injection of an inert gas into the molding cavity (310) and into the melting enclosure (355). The power supply of the melting coil (365) makes it possible to melt the charge (190). The resulting Laplace forces of the induced currents circulating in the sectors of the melting crucible (360) and the sectorized piston (380) distance the melting charge from the walls thereof, such that the molten charge is found to be in electromagnetic levitation or pseudo-levitation without contact.

To carry out casting, the sectorized piston (380) is moved upwards by the means (386) actuating the operating rod (385), which has the effect of pushing the charge (190) into the molding cavity, still without contact between the charge and the piston (380). The cooling of the piston (380) is controlled such that the temperature on the surface of the piston suitable for coming into contact with the pseudo-levitated molten charge is sufficient to prevent the creation of a skull, but not high enough so as to prevent bonding or welding of the molten charge on the surface of the piston.

Prior to casting, the surfaces of the molding cavity (310) are brought to a temperature equal to or slightly less than the glass transition temperature of the BMG used, by energizing with high-frequency current the inductors (320) of the mold, so as to favor uniform filling of the cavity. Then, the molding cavity is rapidly cooled, by circulating a coolant in the cooling channels (125) of the mold. The mold is then opened, the part released from the mold and the cycle is resumed.

According to an alternative embodiment of this embodiment, the device according to the invention comprises an injection crucible connecting the melting crucible and the molding cavity, and a coil surrounding the injection crucible suitable for preserving the temperature of the molten charge during the travel thereof between the melting crucible and the molding cavity.

According to an alternative embodiment of any one of the embodiments of the device according to the invention, the latter comprises a plurality of parallel melting and injection devices to ensure superior filling of the cavity.

In FIG. 4, according to an exemplary embodiment, the piston (185, 385) comprises a plurality of hollow sectors (481, . . . , 486) made of stainless steel or of another electrically conductive and non-magnetic material, open-worked at both lateral ends thereof and electrically insulated from one another by a layer of insulating material, such as a ceramic. The layer of insulating material also ensures tightness between the sectors. The sectors are linked with the operating rod (185, 385) via a cooling baffle (490) made of an electrically insulating material. The cooling baffle is hydraulically connected with fluid circulation means (not shown) via an orifice (491) formed in the operating rod, and distributes the coolant in all the sectors (481, . . . , 486) to ensure the cooling thereof. To this end, the sectors comprise on the bottom face thereof an orifice (493) placing the inside of the sector in contact with the cooling baffle (490). A second orifice (494) at the internal radial end of the sector connects the inside of each sector with an orifice (492) formed in the operating rod, in turn hydraulically connected with the circulation means, which enables the circulation of a coolant in the sectors of the piston.

In FIGS. 4 and 5, when such a sector (486) of the piston is positioned in the alternating magnetic field generated by the melting coil of the melting device, induced currents (500) circulate on the surface thereof over the entire perimeter thereof. These induced currents generate a Laplace force oriented in the positive y direction in FIG. 5, which keeps the melting charge at a distance from the surface of the piston.

In FIG. 6, according to an example of implementation of the method according to the invention, regardless of the embodiment of the device, the latter comprises a first step (610) for charging the melting crucible. This step is carried out with the mold closed or mold open in the case where the melting device is positioned above the mold and with the mold open when the crucible is positioned below the mold. According to a closing step (620), the mold is closed and the molding cavity, as well as the melting crucible are evacuated. According to one alternative embodiment, after the evacuation and optionally flushing, consisting of a succession of evacuations and injection of an inert gas, an inert gas such as argon is injected into the molding cavity and the enclosure of the melting device, the gas being slightly pressurized with respect to atmospheric pressure. According to a melting step (630), the charge is melted by powering the melting coil of the melting device. In parallel or concomitantly, the mold is preheated by the inductors during a heating step (640) so as to bring the surfaces of the molding cavity to a temperature equal to or slightly less than the glass transition temperature of the BMG. Heating by induction makes it possible to attain such a temperature in 1 minute or less according to size of the cavity. According to a casting step (650), the piston is moved downwards or upwards, according to the embodiment of the mold, and the injection coil is powered, as well as the coil surrounding the injection crucible, if the device is provided therewith so as to fill the preheated molding cavity with the molten material. According to the features of the operation, the heating of the molding cavity is optionally maintained during the casting step. According to a cooling step (660), the power supply of the inductors of the mold is stopped and the coolant is circulated in the cooling channels of the mold, providing rapid cooling of the part, until the latter attains the mold release temperature thereof. According to a mold release step (670), the cooled mold is opened, the part is released from the mold, and the cycle is resumed.

In sum, the method and the device according to the invention make it possible to produce amorphous metal parts at a high working speed, more particularly thin parts, while ensuring a high degree of amorphization thereof.

1-14. (canceled)

15. A device to produce a part by molding a bulk metallic glass (BMG), comprising:
a mold comprising two dies delimiting a sealed molding cavity;
a melting device to melt the BMG comprising:
a cold sectorized crucible, or melting crucible, arranged vertically comprising hollow sectors formed from an electrically conductive and non-magnetic material electrically insulated from one another;
an inductor in a form of a coil surrounding the melting crucible to heat a content in the melting crucible;
a current generator to generate an alternating current of a frequency between 10 KHz and 200 KHz to power the inductor; and
an injection crucible to connect the content of the melting crucible with the sealed molding cavity to enable casting of the BMG; and
a sectorized piston comprising hollow sectors made of an electrically conductive and non-magnetic material electrically insulated from one another, one end of the sectorized piston closing the melting crucible, and the sectorized piston is configured to circulate currents, induced by an alternating magnetic field of the inductor powered by the alternating current of the current generator, in the hollow sectors of the sectorized piston to generate a force to repel the BMG located in the melting crucible from a surface of the sectorized piston.

16. The device according to claim 15, wherein the injection crucible is configured to move the sectorized piston vertically.

17. The device according to claim 16, wherein the injection crucible comprises a rack-and-pinion system, an electric cylinder or a linear motor.

18. The device according to claim 16, wherein the melting crucible is positioned above the molding cavity and the sectorized piston moves downward.

19. The device according to claim 16, wherein the melting crucible is positioned below the molding cavity and the sectorized piston moves upward.

20. The device according to claim 15, further comprising a coil surrounding the injection crucible and the coil being powered by the current generator.

21. The device according to claim 15, further comprising an injection coil and an electrical power supply to supply to the injection coil, the injection coil being configured to produce an electromagnetic force to inject a molten material contained in the melting crucible into the molding cavity by the injection crucible.

22. The device according to claim 21, wherein the injection coil is a flat coil powered by a capacitor discharge.

23. The device according to claim 21, wherein the injection coil comprises a coil imbricated in a melting coil surrounding the melting crucible, the melting coil being powered by the alternating current of the current generator, and the injection coil being powered by another alternating current out of phase with respect to the alternating current powering the melting coil so as to generate a sliding field.

24. The device according to claim 15, wherein the hollow sectors of the melting crucible and the sectorized piston are made of stainless steel.

25. The device according to claim 15, wherein the mold comprises a mold induction circuit to heat the molding cavity.

26. The device according to claim 25, wherein the mold induction circuit is configured to cool the molding cavity.

27. A method for molding a part from a BMG implementing device according to claim 26 and comprising:
charging the melting crucible closed by the sectorized piston;
closing the mold and evacuating the molding cavity;
melting a charge contained in the melting crucible using the inductor, the sectorized piston being subjected to the alternating magnetic field of the inductor;
preheating the mold by the mold induction circuit to bring surfaces of the molding cavity to a temperature equal to or substantially equal to a glass transition temperature of the BMG;
carrying out casting by moving the sectorized piston;
cooling the mold by circulating a coolant in the mold induction circuit;
opening the mold and releasing the part.

28. The method according to claim 27, wherein melting and preheating are performed in parallel.
